(19) United States
(12) Patent Application Publication
(10) Pub. No.: US 2023/0142307 A1
(43) Pub. Date: May 11, 2023

(54) ELECTRICAL STORAGE MODULE

(71) Applicant: Panasonic Intellectual Property Management Co., Ltd., Osaka (JP)

(72) Inventors: Yuichi TASHIRO, Kyoto (JP); Kiyoshi WAKINAKA, Osaka (JP); Toru KOBAYASHI, Kyoto (JP)

(21) Appl. No.: 17/913,368

(22) PCT Filed: Mar. 22, 2021
(86) PCT No.: PCT/JP2021/011760

§ 371 Date: Sep. 21, 2022

(30) Foreign Application Priority Data
Mar. 23, 2020 (JP) 2020-051852

(51) Int. Cl. H01M 50/271; H01G 11/10; H01M 50/107; H01M 50/171

(52) U.S. Cl. CPC H01M 50/271; H01G 11/10; H01M 50/107; H01M 50/171

(57) ABSTRACT

An electrical storage module includes: an electrical storage device; a case in which an electrical storage device is housed; and a lid configured to cover an opening part of the case. The case includes a groove part at an outer periphery of the opening part, and the lid includes a rib configured to be inserted into the groove part. A sealing member is present between the rib and the groove part. The sealing member, in a state of having viscosity, is accommodated in the groove part, and then is cured, and the viscosity becomes low. The sealing member is an adhesive.

### CROSS-REFERENCE TO RELATED APPLICATIONS

This application is the U.S. National Phase under 35 U.S.C. § 371 of International Patent Application No. PCT/JP2021/011760, filed on Mar. 22, 2021, which in turn claims the benefit of Japanese Patent Application No. 2020-051852, filed on Mar. 23, 2020, the entire content of each of which is incorporated herein by reference.

### TECHNICAL FIELD

The present invention relates to an electrical storage module.

### BACKGROUND ART

A battery case that includes: a tray member for supporting a battery; a cover member fixed to the tray member so as to be superposed on the tray member; and a gasket interposed between the tray member and the cover member is described in Patent Literature 1, for example.

In the battery case of Patent Literature 1, a tray-side flange part is provided to a peripheral wall of the tray member. In the joint face of the tray-side flange part, a recessed groove part is formed along the peripheral direction, and a gasket is accommodated in this groove part. Meanwhile, in the cover member, a cover-side flange part is formed at the periphery of a cover body part. When the cover member is joined to the tray member, the joint face of the cover-side flange part comes into contact with the joint face of the tray member-side flange part, and comes into contact with the gasket.

### CITATION LIST

### Patent Literature

[PTL 1] Japanese Laid-Open Patent Publication No. 2012-124131

### SUMMARY OF THE INVENTION

### Problems to Be Solved by the Invention

In the above battery case, a waterproof property between the tray member and the cover member is ensured by the gasket. However, when a battery unit configured by a battery being housed in the above battery case is used in an environment in which the battery unit is more likely to be exposed to water, a higher waterproof property is required so as to prevent water from entering the inside of the battery case.

In view of the above problem, an object of the present invention is to provide an electrical storage module that can improve the waterproof property between a case in which an electrical storage device is housed, and a lid which covers an opening part of the case.

### Solution to the Problems

An electrical storage module according to a major aspect of the present invention includes: an electrical storage device; a case in which the electrical storage device is housed; and a lid configured to cover an opening part of the case. Here, the case includes a recess at an outer periphery of the opening part, the lid includes a first protrusion configured to be inserted into the recess, and a sealing member is present between the first protrusion and the recess.

### Advantageous Effects of the Invention

According to the present invention, waterproof property between the case in which the electrical storage device is housed and the lid which covers the opening part of the case can be improved.

The effects and the significance of the present invention will be further clarified by the description of the embodiment below. However, the embodiment below is merely an example for implementing the present invention. The present invention is not limited by the description of the embodiment below in any way.

### BRIEF DESCRIPTION OF THE DRAWINGS

FIG. 1 is a perspective view of an electrical storage module according to an embodiment.

FIG. 2 is an exploded perspective view of the electrical storage module according to the embodiment.

FIG. 3 is a perspective view of electrical storage devices, a device holder, a circuit board, and a lid, which have been integrated, viewed from the front and below, according to the embodiment.

FIGS. 4A to 4C are respectively a front perspective view, a bottom perspective view, and a plan view of the lid having a connector formed integrally therewith, according to the embodiment.

FIGS. 5A and 5B are respectively enlarged partial cross-sectional views of a front portion of the lid cut at the positions of a line A-A′ and a line B-B′ in FIG. 4B, according to the embodiment.

FIGS. 6A and 6B are respectively a front perspective view and a rear perspective view of a case according to the embodiment.

FIG. 7 is a plan view of the case according to the embodiment.

FIG. 8A is an enlarged partial cross-sectional view of the case cut along a line C-C′ in FIG. 7, according to the embodiment, and FIG. 8B is an enlarged partial cross-sectional view of the case in a state where an adhesive has been injected into a groove part, cut along the line C-C′ in FIG. 7, according to the embodiment.

FIGS. 9A and 9B are enlarged partial cross-sectional views of a front portion of the electrical storage module cut at the same position as the line A-A′ in FIG. 4B, according to the embodiment.

FIG. 10 is an enlarged partial cross-sectional view of a front portion of the electrical storage module cut at the same position as the line B-B′ in FIG. 4B, according to the embodiment.

FIGS. 11A and 11B are diagrams for describing a configuration of an electrical storage module according to a modification.

FIGS. 12A and 12B are diagrams for describing a configuration of a case according to a modification.

It is noted that the drawings are solely for description and do not limit the scope of the present invention in any way.

### BEST MODE FOR CARRYING OUT THE INVENTION

Hereinafter, an electrical storage module 1 according to the present embodiment will be described with reference to the drawings. For convenience, front, rear, left, right, up, and down directions are indicated in the drawings, as appropriate. It should be noted that the directions in the drawings merely indicate relative directions with respect to the electrical storage module 1, and do not indicate absolute directions. In addition, for convenience of description, some components are denoted by names according to directions in the drawings, such as “bottom face part”, “front side face part”, and the like.

In the present embodiment, an inner peripheral bottom face 402a corresponds to “sixth face part” described in the claims, and an outer peripheral bottom face 402b corresponds to “third face part” described in the claims. Mounting holes 411, 414 correspond to “fitting hole” described in the claims. Further, an outer peripheral rib 451 corresponds to “second protrusion” described in the claims. Further, a rib 460 corresponds to “first protrusion” described in the claims. Further, a leading end face 461a corresponds to “fourth face part” described in the claims. Further, an inner peripheral upper face 531a corresponds to “first face part” described in the claims. Further, an outer peripheral upper face 531b corresponds to “second face part” described in the claims. Further, a groove part 532 corresponds to “recess” described in the claims. Further, an inner peripheral side face 532b corresponds to “fifth face part” described in the claims, and “side face” described in claim 12 of the claims. Further, an outer peripheral side face 532c corresponds to “side face” described in the claims. Further, emboss processing 533 corresponds to “surface roughening processing” described in the claims. Further, an inner peripheral wall face 507 corresponds to “inner wall face” described in the claims.

However, the above description is merely for providing correspondence between the configurations described in the claims and the configurations of the embodiment. This correspondence does not limit the invention described in the claims to the configurations of the embodiment in any way.

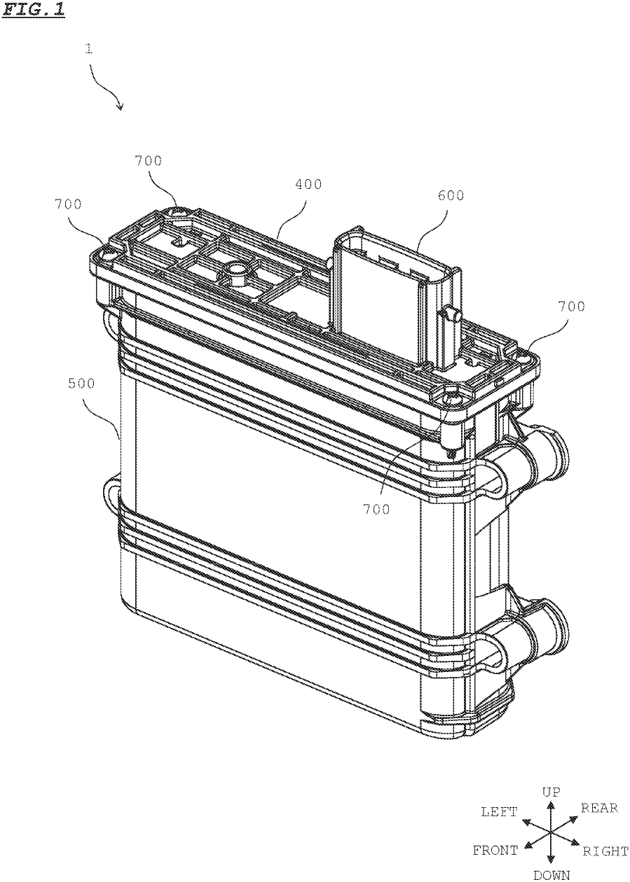

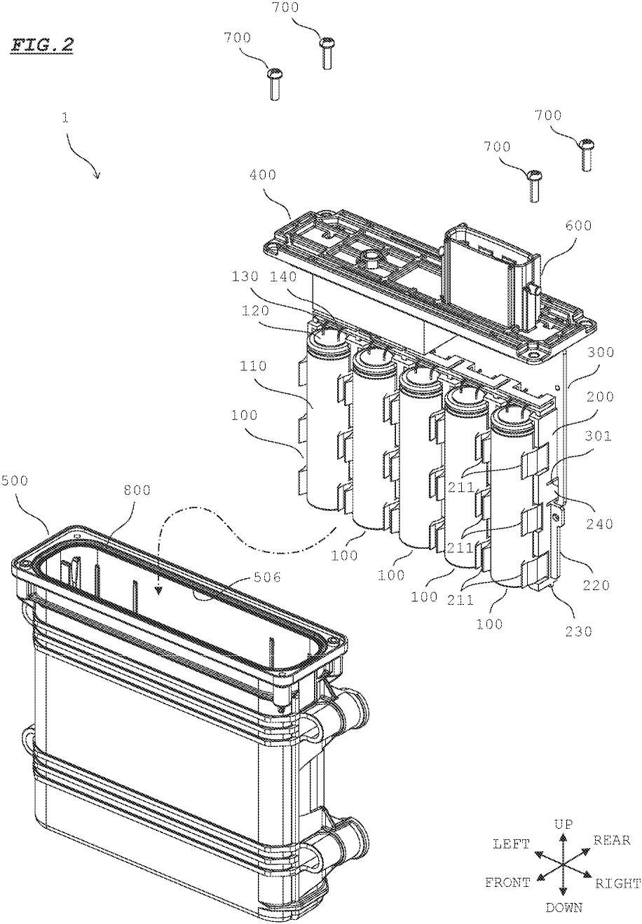

FIG. 1 is a perspective view of the electrical storage module 1 according to the present embodiment. FIG. 2 is an exploded perspective view of the electrical storage module 1 according to the present embodiment.

The electrical storage module 1 includes five electrical storage devices 100, a device holder 200, a circuit board 300, a lid 400, and a case 500. A connector 600 is formed integrally with the lid 400. The device holder 200 in which the five electrical storage devices 100 are held, the circuit board 300, and the lid 400 are integrated, then, the device holder 200 in which the electrical storage devices 100 are held, and the circuit board 300 are housed in the case 500, and an opening part 506 of the case 500 is covered by the lid 400. The lid 400 is fixed to the case 500 by four screws 700. The lid 400 and the case 500 are adhered to each other by an adhesive 800 provided in an annular shape at the outer periphery of the opening part 506. The adhesive 800 that has been cured functions as a sealing member 800 for providing water-sealing between the lid 400 and the case 500.

The electrical storage module 1 is used in various electronic apparatuses, electrical apparatuses, industrial apparatuses, automobiles, and the like, and provides assistance, backup, and the like of power. For example, when the electrical storage module 1 is mounted to an automobile, the electrical storage devices 100 can be charged by power supplied by a battery of the automobile.

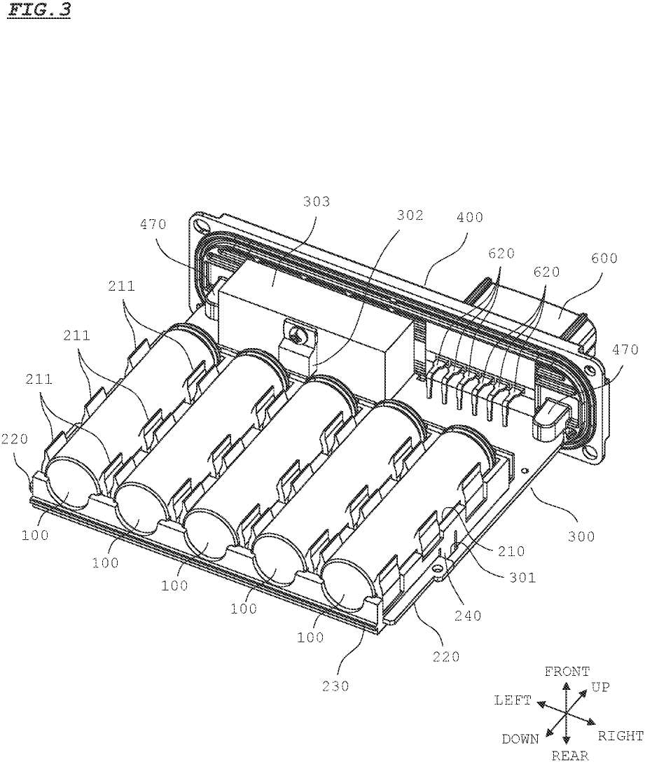

FIG. 3 is a perspective view of the electrical storage devices 100, the device holder 200, the circuit board 300, and the lid 400, which have been integrated, viewed from the front and below, according to the present embodiment.

Each electrical storage device 100 is an electric double layer capacitor, for example. The electrical storage device 100 may be a capacitor, such as a lithium ion capacitor, other than an electric double layer capacitor. An electrical storage device 100 in which a conductive polymer is used as an active material of the positive electrode may be adopted. Examples of the conductive polymer include polyaniline, polypyrrole, or polythiophene, derivatives thereof, and the like. A plurality of types of conductive polymers may be used.

Each electrical storage device 100 includes: a container 110 having a slender bottomed cylindrical shape and containing a device element (not shown) and an electrolytic solution; a sealing body 120 which is formed from an elastic material containing a rubber component and which seals the opening of the container 110; and a positive electrode lead terminal 130 and a negative electrode lead terminal 140 which are drawn from the sealing body 120 to the outside. The positive electrode lead terminal 130 is electrically connected to the positive electrode of the device element, and the negative electrode lead terminal 140 is electrically connected to the negative electrode of the device element.

The device holder 200 is formed from a resin material such as polybutylene terephthalate (PBT) or polyphenylene sulfide (PPS) .

The device holder 200 includes five accommodation parts 210 continuous in the left-right direction so as to hold the five electrical storage devices 100 in a state of being arranged in the left-right direction. Each accommodation part 210 is recessed in a semicircular arc shape so as to be able to accommodate a half of the peripheral face of the electrical storage device 100. Each accommodation part 210 is provided with pairs of claw parts 211 at three places in the up-down direction. Each claw part 211 is curved so as to have the same curvature as that of the holding face in the circular arc shape of the accommodation part 210, and protrudes toward the inner side of the accommodation part 210. The holding face of each accommodation part 210 is also provided with pairs of claw parts (not shown) at two places. Each electrical storage device 100 is sandwiched by the pairs of claw parts 211 at the three places, and the pairs of claw parts at the two places, thereby being held in the corresponding accommodation part 210.

At the left and right side faces of the device holder 200, insertion ribs 220 extending in the up-down direction are formed. At the bottom face of the device holder 200, an insertion rib 230 extending in the left-right direction is formed.

The circuit board 300 has a substantially rectangular shape that is long in the left-right direction. The device holder 200 is fixed to the circuit board 300 by a so-called snap fit structure in which claw parts 240 provided at the left and right side faces of the device holder 200 and each having a hook-shaped leading end are inserted in mounting holes 301 of the circuit board 300. The device holder 200 and the circuit board 300 overlap each other in the front-rear direction such that an upper portion of the circuit board 300 protrudes upward and a lower portion of the device holder 200 protrudes downward with respect to each other.

In the circuit board 300, a pattern wiring (not shown) for connecting the five electrical storage devices 100 in series or in parallel is formed. The positive electrode lead terminal 130 and the negative electrode lead terminal 140 of each electrical storage device 100 are connected to the pattern wiring by soldering. In the circuit board 300, a charging circuit (not shown) for charging each electrical storage device 100 by supply of power from an external battery or the like is disposed. In FIG. 2 and FIG. 3, an FET (Field effect transistor) 302 included in the charging circuit, and a heat sink 303 for dissipating heat from the FET 302 are shown.

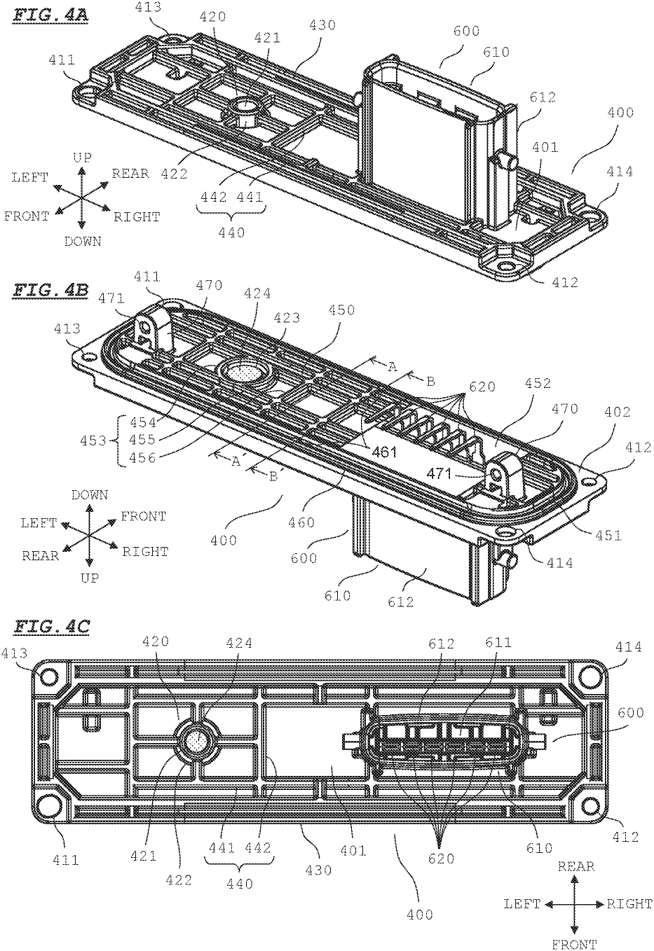

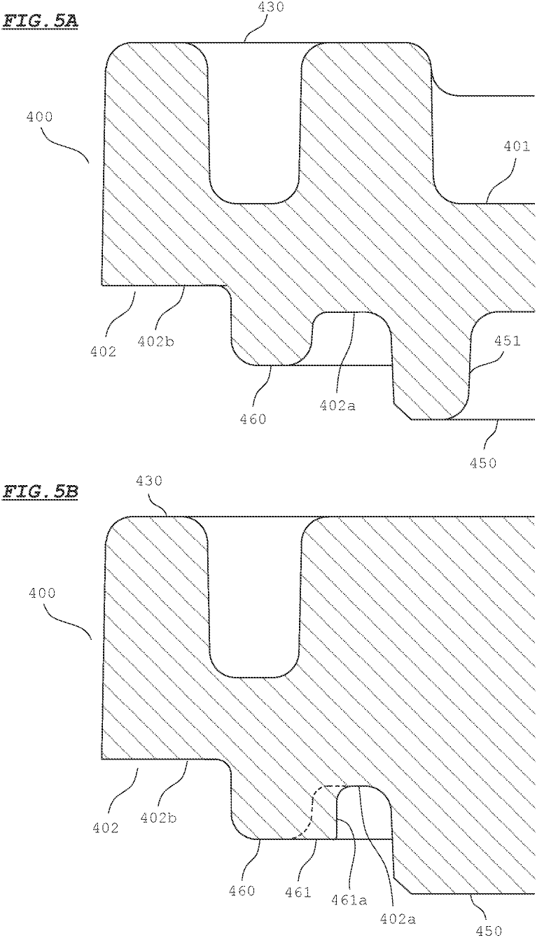

FIGS. 4A to 4C are respectively a front perspective view, a bottom perspective view, and a plan view of the lid 400 having the connector 600 formed integrally therewith, according to the present embodiment. FIGS. 5A and 5B are respectively enlarged partial cross-sectional views of a front portion of the lid 400 cut at the positions of a line A-A′ and a line B-B′ in FIG. 4B, according to the present embodiment.

The lid 400 is formed from a resin material such as polybutylene terephthalate (PBT) or polyphenylene sulfide (PPS). The lid 400 is formed in a plate shape that is long in the left-right direction and substantially rectangular, and four corner portions thereof at the front, rear, left, and right have circular arc shapes. As for the lid 400, a top face 401 thereof is the obverse side, and a bottom face 402 thereof is the reverse side.

Mounting holes 411 to 414 are formed in the lid 400 at four corner portions thereof. Out of the four mounting holes 411 to 414, the mounting hole 411 at the left-front corner portion has an elongated circular shape, and the other mounting holes 412 to 414 at the right-front, left-rear, and right-rear corner portions each have a circular shape. The diameter of the mounting hole 414 at the right-rear corner portion is greater than the diameter of the mounting holes 412, 413 at the right-front and left-rear corner portions. As for the mounting hole 411, the longitudinal direction thereof is parallel to the diagonal connecting the right-front corner and the left-rear corner of the lid 400, and the diameter in the short direction is equal to the diameter of the mounting hole 414.

In the lid 400, a ventilation opening part 420 is provided on the left side with respect to the center. The ventilation opening part 420 includes: a ventilation hole 421 having a circular shape; ribs 422, 423 having annular shapes and formed around the ventilation hole 421 on the top face 401 side and the bottom face 402 side of the lid 400; and a ventilation membrane 424 attached to the rib 423 and covering the ventilation hole 421. The ventilation membrane 424 is a member in which a water-repellent/oil-repellent membrane is formed by laminating a PTFE porous membrane on a substrate composed of a non-woven fabric or a woven fabric made of polyethylene terephthalate (PET) which has been subjected to water-repellent/oil-repellent treatment. The ventilation membrane 424 has a characteristic of repelling water and allowing air to pass therethrough.

In the lid 400, a protruding part 430 having a substantially rectangular frame shape is provided along the outer peripheral edge of the lid 400 so as to project from the top face 401. The protruding part 430 is provided so as to avoid the peripheries of the four mounting holes 411 to 414. The protruding part 430 has a thickness-reduced structure.

In the lid 400, a rib group 440 is provided in a region on the inner side of the protruding part 430 on the top face 401. The rib group 440 has a configuration in which a plurality of ribs 441 extending in the left-right direction and a plurality of ribs 442 extending in the front-rear direction are combined as appropriate, and is connected to the protruding part 430, the rib 422 of the ventilation opening part 420, and the connector 600.

On the bottom face 402 of the lid 400, an inner lid part 450 is provided so as to rise, as a whole, from the bottom face 402. The inner lid part 450 has a shape that corresponds to the shape of the opening part 506 of the case 500, i.e., a rectangular shape that has large circular arcs at four corner portions. The inner lid part 450 enters to the inner side of an inner peripheral wall face 507 of the case 500 when the lid 400 is attached to the case 500. The inner lid part 450 includes an outer peripheral rib 451 having an annular shape and forming an outer peripheral edge portion of the inner lid part 450. The inner lid part 450 includes, on the inner side of the outer peripheral rib 451, a thick portion 452 having a quadrangular shape and increasing the thickness of the region on the reverse side of the connector 600, and includes a rib group 453 in a region other than the thick portion 452. The rib group 453 has a configuration in which: a rib 454 having an annular shape and surrounding the periphery of the rib 423 of the ventilation opening part 420; a plurality of ribs 455 extending in the left-right direction; and a plurality of ribs 456 extending in the front-rear direction, are combined. The rib group 453 is connected to the outer peripheral rib 451 and the thick portion 452.

Further, on the bottom face 402 of the lid 400, a rib 460 having an annular shape that is long in the left-right direction and short in the front-rear direction is formed at the outer periphery of the inner lid part 450. The rib 460 has a substantially quadrate shape in a cross-section thereof, and both corner portions at the leading end are chamfered into circular arc shapes. The height of rib 460 is smaller than the height of the outer peripheral rib 451 of the inner lid part 450. As for the bottom face 402 of the lid 400, the position of a face 402a (hereinafter, referred to as “inner peripheral bottom face 402a”) on the inner side with respect to the rib 460 is lower than the position of a face 402b (hereinafter, referred to as “outer peripheral bottom face 402b”) on the outer side with respect to the rib 460. In the rib 460, a projection 461 projecting toward the inner lid part 450 side, i.e., the inner side of the lid 400, is formed at a center portion in the left-right direction (the longitudinal direction of the lid 400) on each of the front side and the rear side. When the lid 400 has been attached to the case 500, a leading end face 461a of the projection 461 faces the opening part 506 side in a direction along the opening face of the opening part 506.

In the lid 400, mounting bosses 470 are provided at left and right end portions of the inner lid part 450. In each mounting boss 470, a screw hole 471 that is open to the rear is formed.

The connector 600 is formed integrally with the lid 400 and includes a housing 610 and a plurality of terminals 620. The housing 610 has a substantially rectangular parallelepiped box shape that is long in the left-right direction and of which the upper face is open. A part of the lid 400 is shared as a bottom face part 611 of the housing 610. A peripheral face part 612 composed of the front, rear, left, and right side faces of the housing 610 projects from the top face 401 of the lid 400. The plurality of terminals 620 are embedded, by insert molding, in the bottom face part 611 of the housing 610 so as to be arranged in the left-right direction. As for each terminal 620, one end side is accommodated in the housing 610, and the other end side projects to the outside from the inner lid part 450 on the reverse side of the lid 400. The other end side of each terminal 620 is bent in a substantially L-shape.

As shown in FIG. 3, the lid 400 is fixed to an upper end portion of the circuit board 300 as a result of the two mounting bosses 470 on the reverse side being mounted to the circuit board 300 by screws (not shown). Each terminal 620 of the connector 600 is connected to the pattern wiring of the circuit board 300. Accordingly, the five electrical storage devices 100 and the terminals 620 for outputting power from these electrical storage devices 100 are electrically connected to each other. Further, the charging circuit and the terminal 620 for supplying power from a battery to this charging circuit are electrically connected to each other.

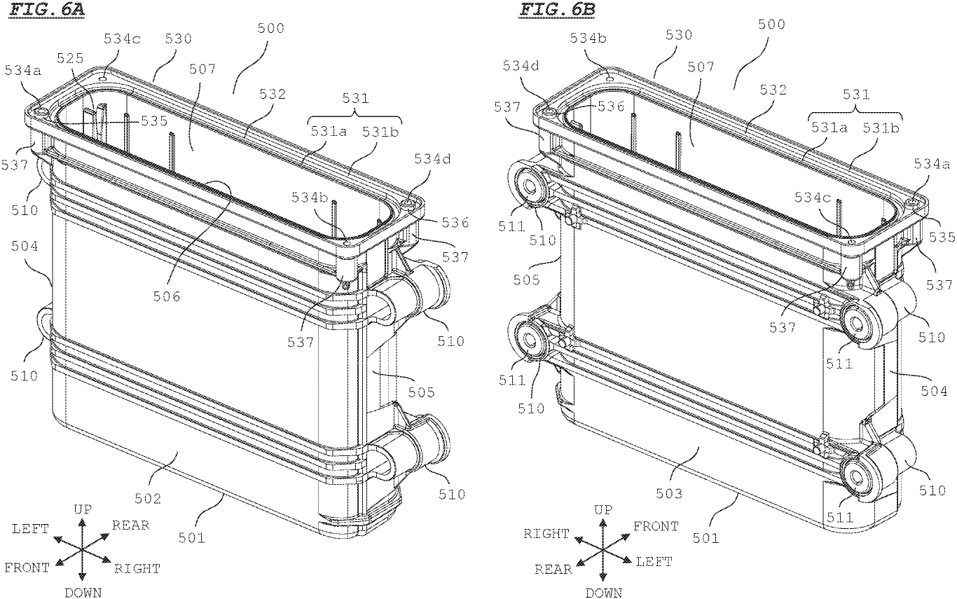

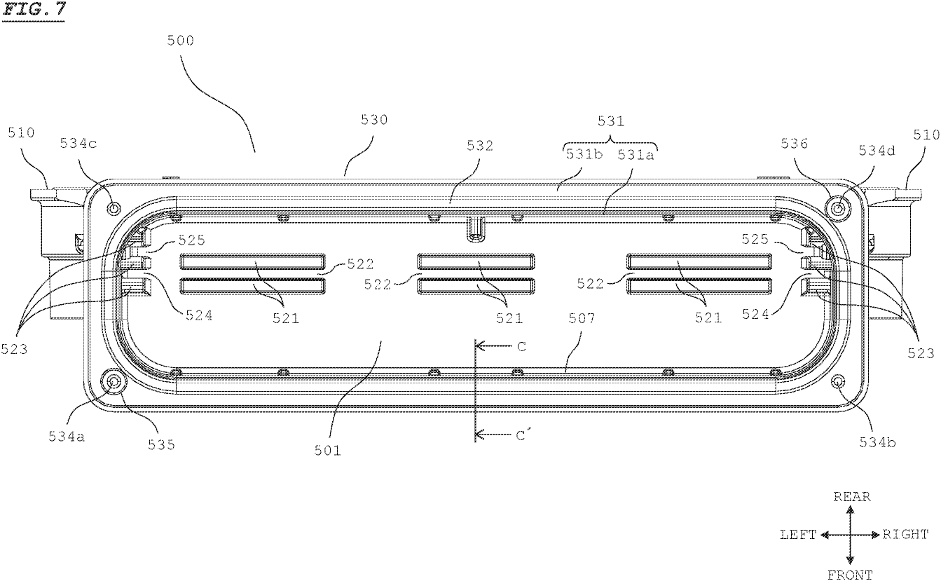

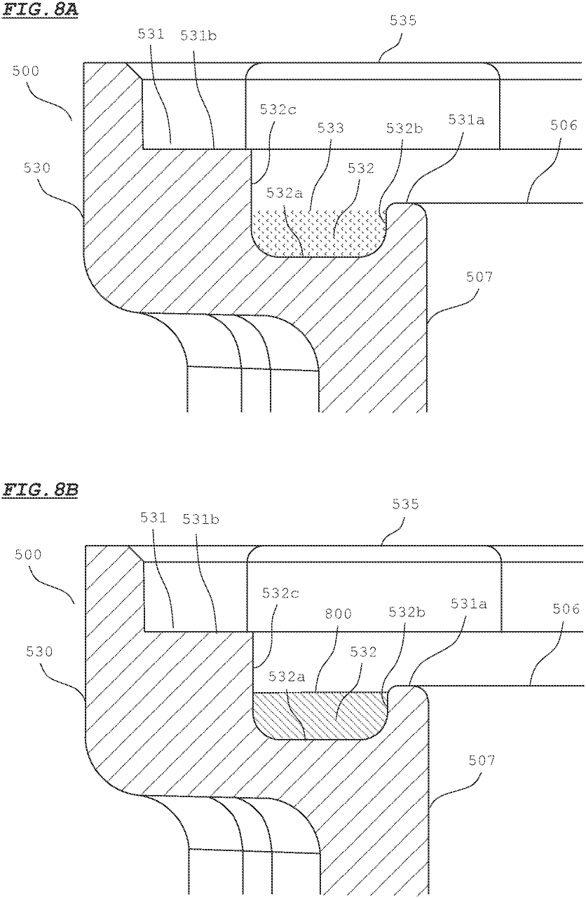

FIGS. 6A and 6B are respectively a front perspective view and a rear perspective view of the case 500 according to the present embodiment. FIG. 7 is a plan view of the case 500 according to the present embodiment. FIG. 8A is an enlarged partial cross-sectional view of the case 500 cut along a line C-C′ in FIG. 7, according to the present embodiment. FIG. 8B is an enlarged partial cross-sectional view of the case 500 in a state where the adhesive 800 has been injected into a groove part 532, cut along the line C-C′ in FIG. 7, according to the present embodiment.

The case 500 is formed from a resin material such as polybutylene terephthalate (PBT) or polyphenylene sulfide (PPS). The case 500 is formed in a substantially rectangular parallelepiped box shape that is wide in the left-right direction and thin in the front-rear direction. The case 500 includes a bottom face part 501, a front side face part 502, a rear side face part 503, a left side face part 504, and a right side face part 505, and has the opening part 506 at the upper end face. In the case 500, four corner portions between the side face parts 502 to 505 are formed in large circular arc shapes. Thus, the shapes of the bottom face part 501 and the opening part 506 of the case 500 are rectangles having large circular arc shapes at four corner portions.

In an upper portion and a lower portion of each of the left side face part 504 and the right side face part 505, mounting bosses 510 each having a substantially round columnar shape and facing rearward are provided. A nut 511 made of metal and having a cylindrical shape is embedded in each mounting boss 510.

Inside the case 500, on the inner wall face of the bottom face part 501, a bottom face holder fixation groove 522 realized by two ribs 521 extending in the left-right direction is provided at three places in the left-right direction. Further, at each of the left side face part 504 and the right side face part 505, a side face holder fixation groove 524 and a board fixation groove 525 realized by three ribs 523 extending in the up-down direction are provided. The bottom face holder fixation grooves 522 and the side face holder fixation grooves 524 are at the same position in the front-rear direction. When the device holder 200 holding the electrical storage devices 100 and the circuit board 300 have been housed in the case 500, the insertion ribs 220 at the side faces of the device holder 200 are inserted into the side face holder fixation grooves 524, and the insertion rib 230 at the bottom face of the device holder 200 is inserted into the bottom face holder fixation grooves 522. Further, a left end portion and a right end portion of the circuit board 300 are respectively inserted into the board fixation grooves 525 of the left side face part 504 and the right side face part 505. Accordingly, the device holder 200 holding the electrical storage devices 100 and the circuit board 300 are fixed inside the case 500.

The inner peripheral wall face 507 is formed by the inner wall faces of the four, i.e., the front, rear, left, and right, side face parts 502, 503, 504, 505 of the case 500.

In the case 500, in an upper end portion thereof, a lid attachment part 530 that has a flange shape and to which the lid 400 is attached is provided. The lid attachment part 530 is recessed into a shape corresponding to the external shape of the lid 400, so as to be able to accommodate the lid 400. An upper face 531 of the lid attachment part 530 serves as an attachment face to which the lid 400 is attached. In the upper face 531 of the lid attachment part 530, the groove part 532, having an annular shape, that circles along the opening edge of the opening part 506 is formed at the outer periphery of the opening part 506. The groove part 532 is chamfered such that the corner portion between a bottom face 532a and a side face 532b (hereinafter, referred to as “inner peripheral side face 532b”) on the inner peripheral side, and the corner portion between the bottom face 532a and a side face 532c (hereinafter, referred to as “outer peripheral side face 532c”) on the outer peripheral side become R-chamfers. As for the upper face 531 of the lid attachment part 530, the position of a face 531a (hereinafter, referred to as “inner peripheral upper face 531a”) on the inner side with respect to the groove part 532 is lower than the position of a face 531b (hereinafter, referred to as “outer peripheral upper face 531b”) on the outer side with respect to the groove part 532. Accordingly, as for the groove part 532, the height of the inner peripheral side face 532b is smaller than the height of the outer peripheral side face 532c. The corner portion between the inner peripheral side face 532b and the inner peripheral upper face 531a is chamfered so as to be an R-chamfer, and the corner portion between the outer peripheral side face 532c and the outer peripheral upper face 531b is not chamfered and is angular.

In the groove part 532, the entire region of the bottom face 532a, the inner peripheral side face 532b, and a region, in the outer peripheral side face 532c, up to the upper end position of the inner peripheral side face 532b are faces having been subjected to emboss processing 533 as surface roughening processing (see FIG. 8A).

In the upper face 531 of the lid attachment part 530, screw holes 534a to 534d having circular shapes are respectively formed at left-front, right-front, left-rear, and right-rear corner portions. Bosses 535, 536 having round columnar shapes are formed at the left-front and right-rear corner portions, and the screw holes 534a, 534d at the left-front and right-rear corner portions are formed in the bosses 535, 536. The outer diameter of each boss 535, 536 is substantially equal to the inner diameter of the mounting hole 414 at the right-rear corner portion of the lid 400. In the lid attachment part 530, a mounting boss 537 is provided at the position of each screw hole 534a to 534d, and each screw hole 534a to 534d extends to the inside of the mounting boss 537.

As shown in FIG. 8B, the adhesive 800 is injected into the groove part 532 of the case 500, before the lid 400 is attached to the case 500. At this time, the position of the boundary of the portion of the emboss processing 533 at the inner peripheral side face 532b and the outer peripheral side face 532c of the groove part 532 serves as a mark for the injection amount, and the adhesive 800 is injected up to the position of the boundary.

As the adhesive 800, a moisture-curing silicon adhesive, a heat-curing epoxy adhesive, or the like can be used, for example. The adhesive 800 has a characteristic in which a state where the viscosity of the adhesive 800 is low changes to a state where the viscosity is high.

The adhesive 800 is injected, in a state where the viscosity is low, into the groove part 532. Then, in a case of a moisture-curing silicon adhesive, the adhesive 800 reacts with moisture in the atmosphere to be cured, and in a case of a heat-curing epoxy adhesive, the adhesive 800 is cured by being heated, to exhibit adhesiveness, and the viscosity of the adhesive 800 becomes high (hardens).

After the adhesive 800 has been injected into the groove part 532 of the case 500, and before the adhesive 800 is cured, the device holder 200 holding the electrical storage devices 100 and the circuit board 300 are housed in the case 500, and the lid 400 is attached to the lid attachment part 530 of the case 500. The opening part 506 of the case 500 is closed by the lid 400. At this time, the bosses 535, 536 at the left-front and right-rear corner portions of the lid attachment part 530 are fitted in the mounting holes 411, 414 at the left-front and right-rear corner portions of the lid 400. Accordingly, the lid 400 is positioned with respect to the lid attachment part 530, i.e., the case 500, in the front-rear and left-right directions (in directions perpendicular to the attachment direction). The respective mounting holes 411 to 414 of the lid 400 and the respective screw holes 534a to 534d of the case 500 are aligned with each other. The screws 700 passed through the respective mounting holes 411 to 414 are fastened to the respective screw holes 534a to 534d. In this manner, the lid 400 is fixed to the case 500 by the four screws 700. When the adhesive 800 has been cured, the lid 400 and the case 500 are adhered to each other by the adhesive 800. Accordingly, the electrical storage module 1 is assembled.

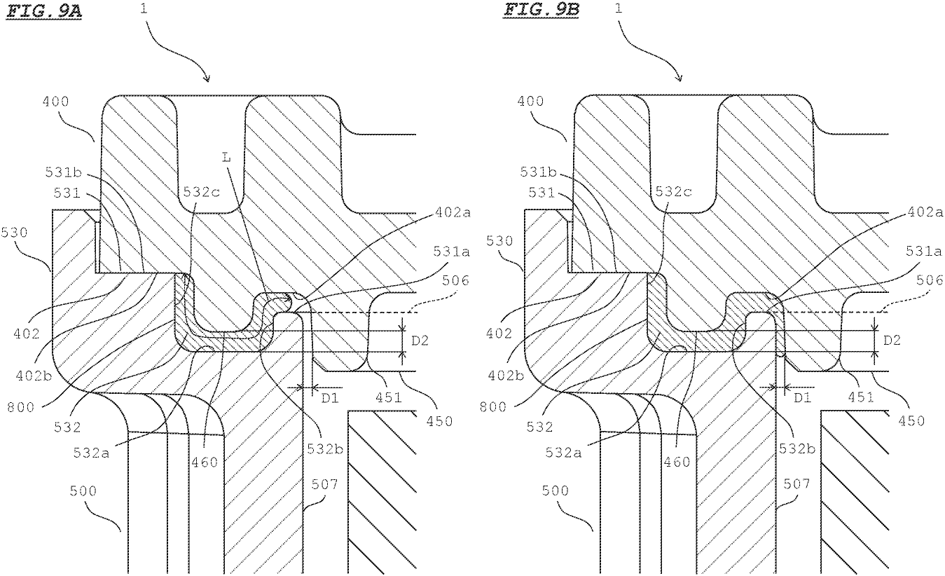

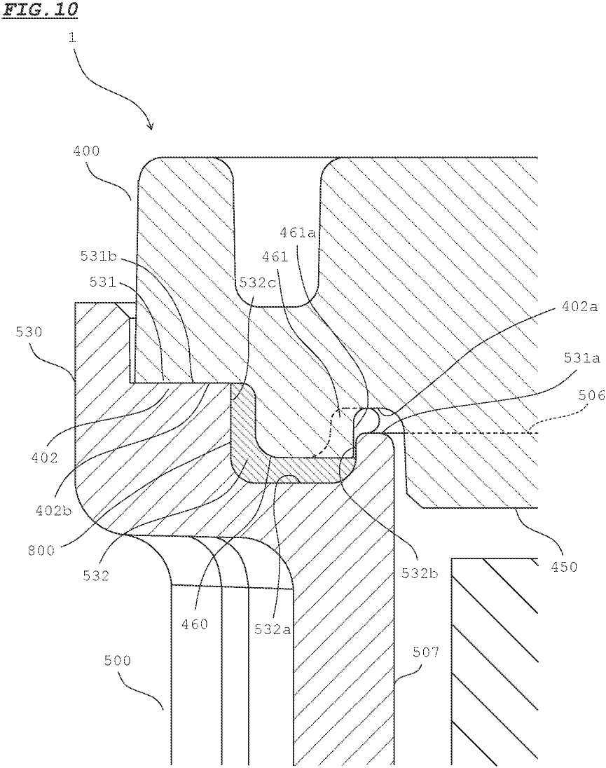

FIGS. 9A and 9B are enlarged partial cross-sectional views of a front portion of the electrical storage module 1 cut at the same position as the line A-A′ in FIG. 4B, according to the present embodiment. FIG. 10 is an enlarged partial cross-sectional view of a front portion of the electrical storage module 1 cut at the same position as the line B-B′ in FIG. 4B, according to the present embodiment.

When the lid 400 has been attached to the case 500, the outer peripheral bottom face 402b of the lid 400 comes into contact with the outer peripheral upper face 531b of the case 500, and the inner peripheral bottom face 402a of the lid 400 is opposed to the inner peripheral upper face 531a of the case 500 with a predetermined distance therebetween. In addition, the rib 460 of the lid 400 is inserted into the groove part 532 of the case 500. The rib 460 is pushed into the adhesive 800 which is present in the groove part 532 and which has a high viscosity before being cured. Accordingly, the adhesive 800 is pushed toward the bottom face 532a side of the groove part 532, to be deformed so as to be spread sideways, thereby entering between the rib 460 and the outer peripheral side face 532c of the groove part 532 and entering between the rib 460 and the inner peripheral side face 532b of the groove part 532. In the case 500, the inner peripheral upper face 531a is at a position lower than that of the outer peripheral upper face 531b, and thus, the groove part 532 is shallow on the inner peripheral upper face 531a side. Therefore, as shown in FIG. 9A, the adhesive 800 further enters between the inner peripheral bottom face 402a of the lid 400 and the inner peripheral upper face 531a. The adhesive 800 is cured in a state of being deformed as described above. The cured adhesive 800 is present in a state of being in close contact with the lid 400 and the case 500, between the rib 460 and the groove part 532 and between the inner peripheral bottom face 402a and the inner peripheral upper face 531a, and functions as a sealing member 800 for providing water-sealing between the lid 400 and the case 500. The sealing member 800 has been deformed in a shape like a “U” as a result of the rib 460 having entered the sealing member 800, and a seal length L is longer than the width of the bottom face 532a of the groove part 532. Thus, since the seal length L is made long, the waterproofing effect by the sealing member 800 can be expected to be enhanced.

The inner lid part 450, i.e., the outer peripheral rib 451, of the lid 400 is inserted inside the case 500. A gap having a predetermined distance D1 is formed between the outer peripheral rib 451 and the inner peripheral wall face 507 of the case 500. Therefore, as shown in FIG. 9B, if the injection amount of the adhesive 800 into the groove part 532 is adjusted, when the lid 400 is attached to the case 500, the adhesive 800 can be caused to enter also between the outer peripheral rib 451 and the inner peripheral wall face 507 of the case 500, whereby the seal length L of the sealing member 800 can be made longer. The distance D1 between the outer peripheral rib 451 and the inner peripheral wall face 507 is smaller than a distance D2 between the leading end of the rib 460 and the bottom face 532a of the groove part 532. Therefore, increase in the amount of the sealing member 800, i.e., the adhesive 800, can be suppressed to a low level.

As shown in FIG. 10, the leading end face 461a of the projection 461 of the rib 460 is close to the inner peripheral side face 532b of the groove part 532. When the case 500 is exposed to a high temperature, the case 500 is likely to be deformed such that the opening part 506 is expanded. In particular, this deformation is likely to occur in a center portion in the longitudinal direction (left-right direction) of the case 500. When such a deformation of the case 500 has occurred, the inner peripheral side face 532b of the groove part 532 comes into contact with the leading end face 461a of the projection 461. Accordingly, deformation of the case 500 is suppressed. It should be noted that, in a state before the case 500 has been deformed, the leading end face 461a of the projection 461 may be in contact with the inner peripheral side face 532b of the groove part 532.

When the electrical storage module 1 is mounted to an external apparatus provided in an automobile or the like, the rear side face part 503 side of the case 500 is fixed to a fixation part of the external apparatus by screwing at the mounting bosses 510. Then, a connector (not shown) provided to the external apparatus is connected to the connector 600 of the electrical storage module 1. When assistance, backup, or the like of power becomes necessary on the external apparatus side, power outputted from the five electrical storage devices 100 is supplied to the external apparatus through the connector 600 and the connector of the external apparatus.

When temperature rise has occurred in the case 500 due to heat generation or the like of the electrical storage device 100 during use, air in the case 500 expands. At this time, the expanded air passes through the ventilation membrane 424 to be released from the ventilation hole 421 to the outside. Therefore, rising of the internal pressure of the case 500 can be prevented. Meanwhile, even when water has entered from the ventilation hole 421, the water cannot pass through the ventilation membrane 424. Therefore, entry of water into the case 500 is prevented.

### Effect of Embodiment

The electrical storage module 1 of the present embodiment has been described above. According to the electrical storage module 1 of the present embodiment, the following effects can be exhibited.

The electrical storage module 1 is configured such that: the case 500 includes the groove part 532 at the outer periphery of the opening part 506; the lid 400 includes the rib 460 to be inserted into the groove part 532; and the sealing member 800 is present between the rib 460 and the groove part 532.

According to this configuration, as shown in FIG. 9A, the rib 460 can be pushed into the sealing member (adhesive) 800, and the sealing member 800 can be deformed to enter between the rib 460 and the outer peripheral side face 532c of the groove part 532, and enter between the rib 460 and the inner peripheral side face 532b of the groove part 532. Accordingly, the seal length L of the sealing member 800 can be made long, and thus, the waterproofing effect between the lid 400 and the case 500 by the sealing member 800 can be expected to be enhanced.

The sealing member (adhesive) 800 has a characteristic in which a state where the viscosity of the sealing member (adhesive) 800 is low changes to a state where the viscosity is high. Therefore, when the rib 460 is inserted into the groove part 532 in a state where the viscosity of the sealing member 800 is low, and the rib 460 is pushed into the sealing member 800, the sealing member 800 can be easily deformed. Therefore, the seal length L of the sealing member 800 can be easily made long.

Further, since the sealing member 800 is an adhesive, the lid 400 and the case 500 can be adhered to each other. Therefore, the lid 400 and the case 500 can be fixed to each other by a small number of screws 700.

Further, the case 500 includes the inner peripheral upper face 531a and the outer peripheral upper face 531b respectively on the inner side and the outer side of the groove part 532, and the position of the inner peripheral upper face 531a is lower than the position of the outer peripheral upper face 531b.

According to this configuration, as shown in FIG. 9A, the groove part 532 is shallow on the inner peripheral upper face 531a side, and the sealing member (adhesive) 800 becomes able to enter between the inner peripheral bottom face 402a of the lid 400 and the inner peripheral upper face 531a. Since the sealing member 800 is present also between the inner peripheral bottom face 402a of the lid 400 and the inner peripheral upper face 531a, the seal length L of the sealing member 800 can be made even longer, and the waterproofing effect can be further enhanced.

Further, the lid 400 includes, on the inner side of the rib 460, the outer peripheral rib 451 to be inserted inside the case 500, and a gap is formed between the inner peripheral wall face 507 of the case 500 and the outer peripheral rib 451.

According to this configuration, as shown in FIG. 9B, the sealing member (adhesive) 800 can be caused to enter also between the outer peripheral rib 451 and the inner peripheral wall face 507 of the case 500, whereby the seal length L of the sealing member 800 can be made even longer.

Further, the distance D1 between the inner peripheral wall face 507 of the case 500 and the outer peripheral rib 451 of the lid 400 which form a gap is smaller than the distance D2 between the leading end of the rib 460 and the bottom face 532a of the groove part 532. Therefore, increase in the amount of the sealing member 800 can be suppressed to a low level.

Further, as shown in FIG. 10, the lid 400 includes the leading end face 461a of the projection 461 facing, at the rib 460, the inner side. The case 500 includes the inner peripheral side face 532b, of the groove part 532, that is close to the leading end face 461a.

According to this configuration, when deformation of the case 500 so as to expand the opening part 506 has occurred, the inner peripheral side face 532b of the groove part 532 comes into contact with the leading end face 461a of the projection 461. Accordingly, deformation of the case 500 can be suppressed.

Further, as shown in FIG. 9A, the outer peripheral bottom face 402b of the lid 400 is in contact with the outer peripheral upper face 531b of the case 500. Therefore, water is less likely to enter up to the groove part 532 from outside. In addition, the corner portion between the outer peripheral upper face 531b of the case 500 and the outer peripheral side face 532c of the groove part 532 is in an angular state. Therefore, at an entrance portion to the groove part 532, a gap is less likely to occur between the outer peripheral upper face 531b of the case 500 and the outer peripheral bottom face 402b of the lid 400, and water is further less likely to enter up to the groove part 532 from the outside.

Further, the case 500 includes, on the outer peripheral side with respect to the opening part 506, the bosses 535, 536 including the screw holes 534a, 534d to which the screws 700 are fastened, and the lid 400 includes the mounting holes 411, 414 in which the bosses 535, 536 are fitted.

According to this configuration, when the bosses 535, 536 are fitted in the mounting holes 411, 414, the lid 400 is positioned in the in-plane direction (front-rear and left-right directions) of the opening face of the opening part 506, with respect to the case 500. Accordingly, the lid 400 can be accurately fixed to the case 500.

Further, since the bottom face 532a of the groove part 532 is a face having been subjected to the emboss processing 533, the lid 400 and the case 500 can be more easily adhered by the adhesive 800.

Further, since the inner peripheral side face 532b and the outer peripheral side face 532c of the groove part 532 are also faces having been subjected to the emboss processing 533, the lid 400 and the case 500 are further more easily adhered by the adhesive 800. In addition, the portion of the emboss processing 533 can be used as a mark when the adhesive 800 is loaded into the groove part 532.

Although an embodiment of the present invention has been described, the present invention is not limited to the above embodiment. In addition, application examples of the present invention can also be modified in various ways, in addition to the above embodiment.

For example, in the above embodiment, the sealing member 800 is implemented by the cured adhesive 800. However, the sealing member 800 may be implemented by any material as long as the material can be deformed when the rib 460 is pushed thereinto. For example, the sealing member 800 may be implemented by an ultraviolet curing resin that has viscosity and that is cured by application of ultraviolet light. Alternatively, the sealing member 800 may be implemented by an elastic material such as a rubber having a high flexibility.

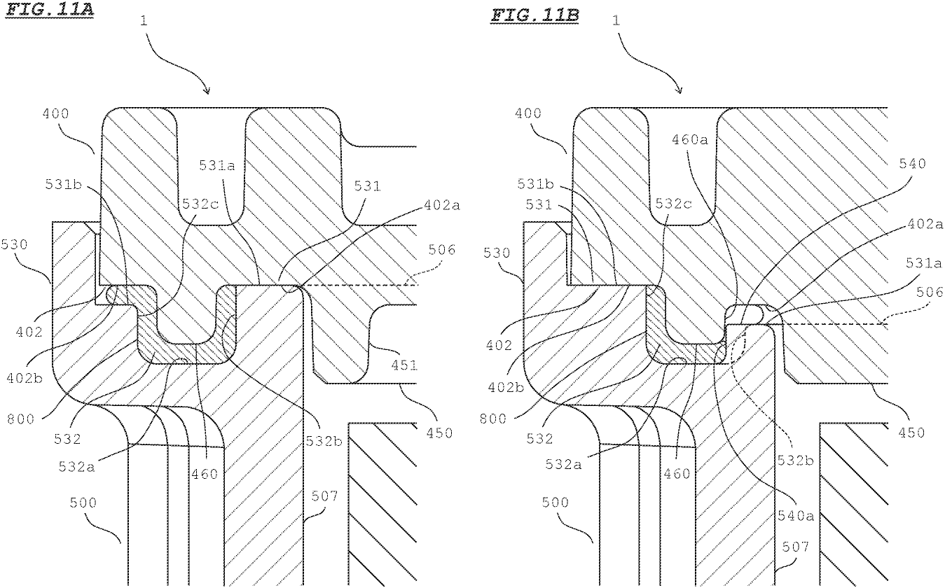

In the above embodiment, the lid attachment part 530 of the case 500 is configured such that the position of the inner peripheral upper face 531a is lower than the position of the outer peripheral upper face 531b. However, as shown in FIG. 11A, the lid attachment part 530 may be configured such that the position of the outer peripheral upper face 531b is lower than the position of the inner peripheral upper face 531a. In this case, the sealing member 800 is present not only between the rib 460 and the groove part 532 but also between the outer peripheral upper face 531b and the outer peripheral bottom face 402b of the lid 400. When such a configuration is adopted as well, the seal length L of the sealing member 800 can be made long.

Further, in the above embodiment, after the adhesive 800 has been disposed (injected) in the groove part 532 of the lid attachment part 530, the rib 460 of the lid 400 is inserted into the groove part 532. However, after the adhesive 800 has been disposed (applied) at the rib 460 of the lid 400, the rib 460 may be inserted into the groove part 532.

Further, in the above embodiment, the projection 461 is formed in the rib 460 of the lid 400. However, as shown in FIG. 11B, a projection 540 projecting to the rib 460 side may be provided to the inner peripheral side face 532b of the groove part 532 of the case 500, and a leading end face 540a of the projection 540 may be close to a side face 460a on the inner side of the rib 460. Further, the leading end face 540a of the projection 540 and the side face 460a of the rib 460 may be in contact with each other. When such a configuration is adopted as well, deformation of the case 500 so as to expand the opening part 506 can be suppressed. It should be noted that the side face 460a corresponds to “fourth face part” described in the claims, and the leading end face 540a corresponds to “fifth face part” described in the claims.

Further, the projection 461 of the rib 460 or the projection 540 of the groove part 532 may be provided not only to the center portion in the longitudinal direction of the lid 400 or the case 500, but also to another place.

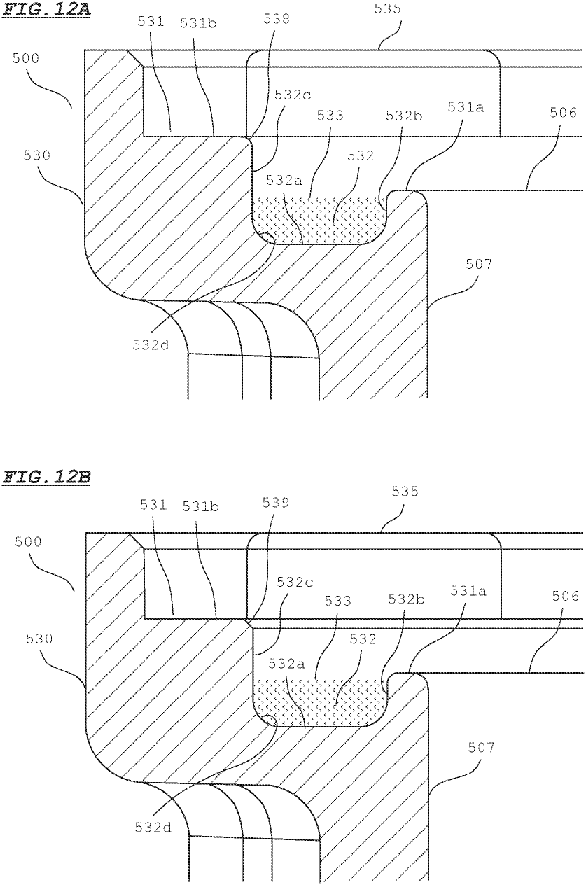

Further, in the above embodiment, with respect to the lid attachment part 530 of the case 500, the corner portion between the outer peripheral side face 532c of the groove part 532 and the outer peripheral upper face 531b is not chamfered, and is angular. However, as shown in FIG. 12A, at the corner portion between the outer peripheral side face 532c of the groove part 532 and the outer peripheral upper face 531b, an R-chamfer 538 of which the chamfer amount is smaller than that of an R-chamfer 532d formed at the corner portion between the bottom face 532a and the outer peripheral side face 532c of the groove part 532, may be formed, or alternatively, as shown in FIG. 12B, a C-chamfer 539 of which the chamfer amount is smaller than that of the R-chamfer 532d may be formed. When these configurations are adopted as well, water is less likely to enter up to the groove part 532 although the effect is reduced when compared with that in the above embodiment.

Further, in the above embodiment, in the lid attachment part 530, the bosses 535, 536 are provided at two corner portions that are in a diagonal relationship. However, bosses may be provided at two corner portions that are at the same position in the left-right direction, or two corner portions that are at the same position in the front-rear direction. Alternatively, bosses may be provided at three or all corner portions. Further, a boss not being a round columnar shape but being in a polygonal columnar shape, such as a quadrangular column, may be provided at one or a plurality of corner portions. In accordance with the above change of the boss, the size and shape of the mounting holes 411 to 414 of the lid 400 are changed.

Further, in the above embodiment, with respect to the lid 400 and the case 500, around the outer periphery of the opening part 506, the rib 460 and the groove part 532 between which the sealing member 800 is present are provided in one loop. However, around the outer periphery of the opening part 506, the rib 460 and the groove part 532 between which the sealing member 800 is present may be provided in two or more loops.

Further, in the above embodiment, the lid 400 is formed in a plate shape. However, the lid 400 may be formed in a box shape of which the lower face is open. In this case, the rib 460 may be formed at the lower end face of the side face part of the lid 400. Alternatively, a flange part may be provided at the lower end of the side face part of the lid 400, and the rib 460 may be formed at the lower face of this flange part.

Further, in the above embodiment, five electrical storage devices 100 are used in the electrical storage module 1. However, not limited thereto, a different number of electrical storage devices 100 may be used in the electrical storage module 1.

Further, in the above embodiment, an electric double layer capacitor is used as the electrical storage device 100. However, as the electrical storage device 100, instead of a capacitor, a lithium ion secondary battery of which the active material of the positive electrode is a lithium transition metal oxide such as lithium cobalt oxide and the active material of the negative electrode is a carbon material may be used, for example. Further, the electrical storage device 100 need not be such a nonaqueous electrolyte secondary battery, but may be a secondary battery other than the nonaqueous electrolyte secondary battery, or may be a primary battery.

In addition to the above, various modifications can be made as appropriate to the embodiment of the present invention without departing from the scope of the technical idea defined by the claims.

In the description of the embodiments above, the terms that indicate directions such as “upper” and “lower” are relative directions that are dependent only on the relative positional relationship between component members, and do not indicate absolute directions such as the vertical direction and the horizontal direction.

### Industrial Applicability

The present invention is useful for an electrical storage module that is used in various types of electronic apparatuses, electrical apparatuses, industrial apparatuses, electrical equipment of vehicles, and the like.

DESCRIPTION OF THE REFERENCE CHARACTERS
1 electrical storage module
100 electrical storage device
400 lid
402a inner peripheral bottom face (sixth face part)
402b outer peripheral bottom face (third face part)
411, 414 mounting hole (fitting hole)
451 outer peripheral rib (second protrusion)
460 rib (first protrusion)
460a side face (fifth face part)
461a leading end face (fourth face part)
500 case
531a inner peripheral upper face (first face part)
531b outer peripheral upper face (second face part)
532 groove part (recess)
532a bottom face
532 groove part (recess)
532a bottom face
532b inner peripheral side face (fifth face part, side face)
532c outer peripheral side face (side face)
532d R-chamfer
533 emboss processing (surface roughening processing)
535, 536 boss
538 R-chamfer
539 C-chamfer
540a leading end face (fourth face part)
506 opening part
507 inner peripheral wall face (inner wall face)
700 screw
800 adhesive, sealing member
D1 distance
D2 distance

1. An electrical storage module comprising:
an electrical storage device;
a case in which the electrical storage device is housed; and
a lid configured to cover an opening part of the case, wherein
the case includes a recess at an outer periphery of the opening part,
the lid includes a first protrusion configured to be inserted into the recess, and
a sealing member is present between the first protrusion and the recess.

2. The electrical storage module according to claim 1, wherein
the sealing member has a characteristic in which a state where viscosity of the sealing member is low changes to a state where the viscosity is high.

3. The electrical storage module according to claim 2, wherein
the sealing member is an adhesive.

4. The electrical storage module according to claim 1, wherein
the case includes a first face part and a second face part respectively on an inner side and an outer side of the recess, and
one of the first face part and the second face part is present at a position lower than that of another of the first face part and the second face part.

5. The electrical storage module according to claim 4, wherein
the position of the first face part is lower than the position of the second face part, and
the lid includes a third face part configured to be in contact with the second face part.

6. The electrical storage module according to claim 1, wherein
the lid further includes, on an inner side of the first protrusion, a second protrusion configured to be inserted inside the case, and
a gap is formed between an inner wall face of the case and the second protrusion.

7. The electrical storage module according to claim 6, wherein
a distance between the inner wall face of the case and the second protrusion, the inner wall face and the second protrusion forming the gap, is smaller than a distance between a leading end of the first protrusion and a bottom face of the recess.

8. The electrical storage module according to claim 1, wherein
the lid includes a fourth face part facing, at the first protrusion, an inner side, and
the case includes a fifth face part configured to be close to or in contact with the fourth face part.

9. The electrical storage module according to claim 1, wherein
the case includes a first face part and a second face part respectively on an inner side and an outer side of the recess, and
a corner portion between the second face part and a side face, of the recess, connected to the second face part is in an angular state, or in a state of having an R-chamfer or a C-chamfer of which a chamfer amount is smaller than that of an R-chamfer present at a corner portion between a bottom face of the recess and the side face.

10. The electrical storage module according to claim 1, wherein
the case includes a first face part on an inner side of the recess,
the lid includes a sixth face part opposed to the first face part, and
the sealing member is present also between the first face part and the sixth face part.

11. The electrical storage module according to claim 1, wherein
the case includes, on an outer peripheral side with respect to the opening part, a boss including a screw hole to which a screw is fastened, and
the lid includes a fitting hole in which the boss is fitted.

12. The electrical storage module according to claim 1, wherein
the sealing member is an adhesive, and
a bottom face of the recess is a face having been subjected to surface roughening processing.

13. The electrical storage module according to claim 12, wherein
a side face of the recess is also a face having been subjected to surface roughening processing.
